(19) United States
(12) Patent Application Publication
(10) Pub. No.: US 2022/0181635 A1
(43) Pub. Date: Jun. 9, 2022

(54) ASYMMETRIC HYBRID ELECTRODE FOR CAPACITOR-ASSISTED BATTERY

(71) Applicant: GM GLOBAL TECHNOLOGY OPERATIONS LLC, Detroit, MI (US)

(72) Inventors: Dewen Kong, Shanghai (CN); Xiaochao Que, Shanghai (CN); Meiyuan Wu, Shanghai (CN); Haijing Liu, Shanghai (CN)

(73) Assignee: GM GLOBAL TECHNOLOGY OPERATIONS LLC, Detroit, MI (US)

(21) Appl. No.: 17/542,169

(22) Filed: Dec. 3, 2021

(30) Foreign Application Priority Data
Dec. 4, 2020 (CN) 202011404868.X

(51) Int. Cl. H01M 4/62; H01M 4/04

(52) U.S. Cl. CPC H01M 4/625; H01M 4/0404; H01M 4/626; H01M 4/623

(57) ABSTRACT

An asymmetric hybrid electrode for a capacitor-assisted battery includes a current and first and second electroactive portions. The first electroactive portion is on a first surface of the current collector. The first electroactive portion includes a first battery layer. The first battery layer includes a first battery electroactive material and a first binder. The second electroactive portion is on a second surface of the current collector opposite the first surface. The second electroactive portion includes a second battery layer and a capacitive layer. The second battery layer includes a second battery electroactive material and a second binder. The capacitive layer includes a capacitive electroactive material and a third binder. The first and second electroactive portions are asymmetric. The first and second battery electroactive materials are both positive electroactive materials or both negative electroactive materials. The asymmetric hybrid electrode has a capacitor hybridization ratio of 0.01-1%.

### CROSS-REFERENCE TO RELATED APPLICATIONS

This application claims the benefit and priority of Chinese Patent Application No. 202011404868.X, filed Dec. 4, 2020. The entire disclosure of the above application is incorporated herein by reference.

### INTRODUCTION

This section provides background information related to the present disclosure which is not necessarily prior art.

The present disclosure relates to a hybrid electrode, which may be a positive or negative electrode, with asymmetric coating layers. The present disclosure also provides a capacitor-assisted battery including the asymmetric hybrid electrode and methods of fabricating the asymmetric hybrid electrode.

High-energy density electrochemical cells, such as lithium-ion batteries can be used in a variety of consumer products and vehicles, such as battery or hybrid electric vehicles. Battery powered vehicles show promise as a transportation option as technical advances continue to be made in battery power and lifetimes.

### SUMMARY

This section provides a general summary of the disclosure, and is not a comprehensive disclosure of its full scope or all of its features.

In various aspects, the present disclosure provides an asymmetric hybrid electrode for a capacitor-assisted battery. The asymmetric hybrid electrode includes a current collector, a first electroactive portion, and a second electroactive portion. The current collector includes an electrically-conductive material. The first electroactive portion is on a first surface of the current collector. The first electroactive portion includes a first battery layer. The first battery layer includes a first battery electroactive material and a first binder. The second electroactive portion is on a second surface of the current collector opposite the first surface. The second electroactive portion includes a second battery layer and a capacitive layer. The second battery layer includes a second battery electroactive material and a second binder. The capacitive layer includes a capacitive electroactive material and a third binder. The first electroactive portion and the second electroactive portion are asymmetric. The first battery electroactive material and the second battery electroactive material are both positive electroactive materials or both negative electroactive materials. The asymmetric hybrid electrode has a capacitor hybridization ratio of 0.01-1%.

In one aspect, the capacitive layer further includes a third battery electroactive material.

In one aspect, the capacitive layer includes the third battery electroactive material at less than or equal to about 95% by weight of the capacitive electroactive material.

In one aspect, the capacitive layer includes the third battery electroactive material at less than or equal to about 20% by weight of the capacitive electroactive material.

In one aspect, the first battery electroactive material, the second battery electroactive material, and the third battery electroactive material are the same.

In one aspect, the first binder, the second binder, and the third binder are the same.

In one aspect, the first binder, the second binder, and the third binder include polyvinylidene fluoride.

In one aspect, the capacitor hybridization ratio is less than or equal to about 0.7%.

In one aspect, the second battery layer is between the capacitive layer and the current collector.

In one aspect, the first battery layer is directly on the first surface of the current collector.

The second battery layer is directly on the second surface of the current collector. The capacitive layer is directly on the second battery layer.

In one aspect, the first battery layer defines a first thickness of less than 5 mm. The second battery layer defines a second thickness of less than 5 mm.

In one aspect, the first thickness and the second thickness are substantially the same.

In one aspect, the capacitive layer defines a thickness in a range of 1-200 μm.

In one aspect, the first battery electroactive material and the second battery electroactive material are the same.

In one aspect, the first battery electroactive material and the second battery electroactive material are positive electroactive materials.

In one aspect, the positive electroactive materials include an olivine compound. The capacitive electroactive material includes activated carbon. The electrically-conductive material includes aluminum.

In one aspect, the first battery electroactive material and the second battery electroactive material are negative electroactive materials.

In one aspect, the negative electroactive materials include a carbon-based battery electroactive material. The capacitive electroactive material includes a carbon-based capacitive electrode material. The electrically-conductive material includes copper.

In various aspects, the present disclosure provides an electrochemical cell. The electrochemical cell includes the asymmetric hybrid electrode, a positive battery electrode, and a negative battery electrode.

In various aspects, the present disclosure provides a method of manufacturing an asymmetric hybrid electrode for an electrochemical cell. The method includes forming a first battery layer on a first surface of a current collector. The first battery layer includes a first battery electroactive material and a first binder. The current collector includes an electrically-conductive material. The method further includes forming a second battery layer on a second surface of the current collector opposite the first surface. The second battery layer includes a second battery electroactive material and a second binder. The method further includes forming a capacitive layer on the second battery layer. The capacitive layer includes a capacitive electroactive material and a third binder. The first battery layer defines a first electroactive portion. The second battery layer and the capacitive layer cooperate to define a second electroactive portion. The first electroactive portion and the second electroactive portion are asymmetric. The first battery electroactive material and the second battery electroactive material are both positive electroactive materials or are both negative electrode materials. The asymmetric hybrid electrode has a capacitor hybridization ratio of about 0.01-1%.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an electrochemical cell for cycling lithium ions;

FIG. 2 is a schematic illustration of a capacitive electrode;

FIG. 3 is a schematic illustration of a double-sided electrode having a capacitor side and a battery side;

FIG. 4 is a schematic illustration of a symmetric double-sided electrode;

FIG. 5 is a schematic illustration of an asymmetric hybrid electrode according to various aspects of the present disclosure;

FIG. 6 is a schematic illustration of a positive asymmetric hybrid electrode according to various aspects of the present disclosure;

FIG. 7 is a schematic illustration of a negative asymmetric hybrid electrode according to various aspects of the present disclosure;

FIG. 8 is a schematic illustration of a positive battery electrode according to various aspects of the present disclosure;

FIG. 9 is a schematic illustration of a negative battery electrode according to various aspects of the present disclosure;

FIG. 10 is a schematic illustration of a capacitor-assisted battery (“CAB”) according to various aspects of the present disclosure;

FIG. 11 is a schematic illustration of another CAB according to various aspects of the present disclosure;

FIG. 12 is a schematic illustration of yet another CAB according to various aspects of the present disclosure;

FIG. 13 is a flowchart depicting a method of making the asymmetric hybrid electrode of FIG. 5;

FIG. 14 is a schematic illustration of a portion of the method of FIG. 13;

FIG. 15 is a schematic illustration of another portion of the method of FIG. 13;

FIG. 16 is a schematic illustration of yet another portion of the method of FIG. 13;

FIG. 17 is a schematic illustration of yet another portion of the method of FIG. 13;

FIG. 18 is a schematic illustration of yet another portion of the method of FIG. 13; and

FIG. 19 is a schematic illustration of yet another portion of the method of FIG. 13.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to rechargeable lithium-ion batteries, which may be used in vehicle applications. However, the present technology may also be used in other electrochemical devices that cycle lithium ions, such as handheld electronic devices or energy storage systems (ESS).

General Electrochemical Cell Function, Structure, and Composition

An electrochemical cell generally includes a first electrode, such as a positive electrode or cathode, a second electrode such as a negative electrode or an anode, an electrolyte, and a separator. Often, in a lithium-ion battery pack, electrochemical cells are electrically connected in a stack to increase overall output. Lithium-ion electrochemical cells operate by reversibly passing lithium ions between the negative electrode and the positive electrode. The separator and the electrolyte are disposed between the negative and positive electrodes. The electrolyte is suitable for conducting lithium ions and may be in liquid, gel, or solid form. Lithium ions move from a positive electrode to a negative electrode during charging of the battery and in the opposite direction when discharging the battery.

Each of the negative and positive electrodes within a stack is typically electrically connected to a current collector (e.g., a metal, such as copper for the negative electrode and aluminum for the positive electrode). During battery usage, the current collectors associated with the two electrodes are connected by an external circuit that allows current generated by electrons to pass between the negative and positive electrodes to compensate for transport of lithium ions.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. While the positive electroactive materials can be used in batteries for primary or single charge use, the resulting batteries generally have desirable cycling properties for secondary battery use over multiple cycling of the cells.

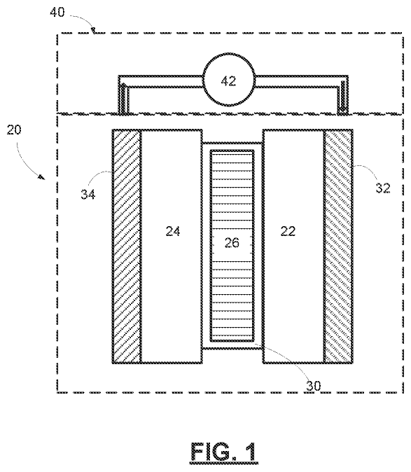

An exemplary schematic illustration of a lithium-ion battery 20 is shown in FIG. 1. The lithium-ion battery 20 includes a negative electrode 22, a positive electrode 24, and a porous separator 26 (e.g., a microporous or nanoporous polymeric separator) disposed between the negative and positive electrodes 22, 24. An electrolyte 30 is disposed between the negative and positive electrodes 22, 24 and in pores of the porous separator 26. The electrolyte 30 may also be present in the negative electrode 22 and positive electrode 24, such as in pores.

A negative electrode current collector 32 may be positioned at or near the negative electrode 22. A positive electrode current collector 34 may be positioned at or near the positive electrode 24. While not shown, the negative electrode current collector 32 and the positive electrode current collector 34 may be coated on one or both sides. In certain aspects, the current collectors may be coated with an electroactive material/electrode layer on both sides. The negative electrode current collector 32 and positive electrode current collector 34 respectively collect and move free electrons to and from an external circuit 40. The interruptible external circuit 40 includes a load device 42 connects the negative electrode 22 (through the negative electrode current collector 32) and the positive electrode 24 (through the positive electrode current collector 34).

The porous separator 26 operates as both an electrical insulator and a mechanical support. More particularly, the porous separator 26 is disposed between the negative electrode 22 and the positive electrode 24 to prevent or reduce physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the lithium-ion battery 20.

The lithium-ion battery 20 can generate an electric current during discharge by way of reversible electrochemical reactions that occur when the external circuit 40 is closed (to electrically connect the negative electrode 22 and the positive electrode 24) when the negative electrode 22 contains a relatively greater quantity of cyclable lithium. The chemical potential difference between the positive electrode 24 and the negative electrode 22 drives electrons produced by the oxidation of lithium (e.g., intercalated/alloyed/plated lithium) at the negative electrode 22 through the external circuit 40 toward the positive electrode 24. Lithium ions, which are also produced at the negative electrode, are concurrently transferred through the electrolyte 30 and porous separator 26 towards the positive electrode 24. The electrons flow through the external circuit 40 and the lithium ions migrate across the porous separator 26 in the electrolyte 30 to intercalate/alloy/plate into a positive electroactive material of the positive electrode 24. The electric current passing through the external circuit 40 can be harnessed and directed through the load device 42 until the lithium in the negative electrode 22 is depleted and the capacity of the lithium-ion battery 20 is diminished.

The lithium-ion battery 20 can be charged or re-energized at any time by connecting an external power source (e.g., charging device) to the lithium-ion battery 20 to reverse the electrochemical reactions that occur during battery discharge. The connection of an external power source to the lithium-ion battery 20 compels the lithium ions at the positive electrode 24 to move back toward the negative electrode 22. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the lithium-ion battery 20 may vary depending on the size, construction, and particular end-use of the lithium-ion battery 20. Some notable and exemplary external power sources include, but are not limited to, AC power sources, such as an AC wall outlet or a motor vehicle alternator. A converter may be used to change from AC to DC for charging the battery 20.

In many lithium-ion battery configurations, each of the negative electrode current collector 32, negative electrode 22, the separator 26, positive electrode 24, and positive electrode current collector 34 are prepared as relatively thin layers (for example, from several microns to a millimeter or less in thickness) and assembled in layers connected in electrical series and/or parallel arrangement to provide a suitable electrical energy and power package. Furthermore, the lithium-ion battery 20 can include a variety of other components that, while not depicted here, are nonetheless known to those of skill in the art. For instance, the lithium-ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. As noted above, the size and shape of the lithium-ion battery 20 may vary depending on the particular application for which it is designed. Battery-powered vehicles and handheld consumer electronic devices are two examples where the lithium-ion battery 20 would most likely be designed to different size, capacity, and power-output specifications. The lithium-ion battery 20 may also be connected in series or parallel with other similar lithium-ion cells or batteries to produce a greater voltage output, energy, and/or power as required by the load device 42.

Accordingly, the lithium-ion battery 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the lithium-ion battery 20 for purposes of storing energy. In certain other variations, the electrochemical cell may be a supercapacitor, such as a lithium-ion based supercapacitor.

### Electrolyte

Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous non-aqueous liquid electrolyte 30 solutions may be employed in the lithium-ion battery 20. In certain variations, the electrolyte 30 may include an aqueous solvent (i.e., a water-based solvent) or a hybrid solvent (e.g., an organic solvent including at least 1% water by weight).

Appropriate lithium salts generally have inert anions. Non-limiting examples of lithium salts that may be dissolved in an organic solvent to form the non-aqueous liquid electrolyte solution include lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium difluorooxalatoborate (LiBF₂(C₂O₄)) (LiODFB), lithium tetraphenylborate (LiB(C₆H₅)₄); lithium bis-(oxalate)borate (LiB(C₂O₄)₂) (LiBOB); lithium tetrafluorooxalatophosphate (LiPF₄(C₂O₄)) (LiFOP), lithium nitrate (LiNO₃), lithium hexafluoroarsenate (LiAsF₆); lithium trifluoromethanesulfonate (LiCF₃SO₃); lithium bis(trifluoromethanesulfonimide) (LITFSI) (LiN(CF₃SO₂)₂); lithium fluorosulfonylimide (LiN(FSO₂)₂) (LIFSI); and combinations thereof. In certain variations, the electrolyte 30 may include a 1 M concentration of the lithium salts.

These lithium salts may be dissolved in a variety of organic solvents, such as organic ethers or organic carbonates, by way of example. Organic ethers may include dimethyl ether, glyme (glycol dimethyl ether or dimethoxyethane (DME, e.g., 1,2-dimethoxyethane)), diglyme (diethylene glycol dimethyl ether or bis(2-methoxyethyl) ether), triglyme (tri(ethylene glycol) dimethyl ether), additional chain structure ethers, such as 1-2-diethoxyethane, ethoxymethoxyethane, 1,3-dimethoxypropane (DMP), cyclic ethers, such as tetrahydrofuran, 2-methyltetrahydrofuran, and combinations thereof. In certain variations, the organic ether compound is selected from the group consisting of: tetrahydrofuran, 2-methyl tetrahydrofuran, dioxolane, dimethoxy ethane (DME), diglyme (diethylene glycol dimethyl ether), triglyme (tri(ethylene glycol) dimethyl ether), 1,3-dimethoxypropane (DMP), and combinations thereof. Carbonate-based solvents may include various alkyl carbonates, such as cyclic carbonates (e.g., ethylene carbonate (EC), propylene carbonate (PC), butylene carbonate) and acyclic carbonates (e.g., dimethyl carbonate (DMC), diethyl carbonate (DEC), ethyl methyl carbonate (EMC)). Ether-based solvents include cyclic ethers (e.g., tetrahydrofuran, 2-methyltetrahydrofuran, 1,3-dioxolane) and chain structure ethers (e.g., 1,2-dimethoxyethane, 1-2-diethoxyethane, ethoxymethoxyethane).

In various embodiments, appropriate solvents in addition to those described above may be selected from propylene carbonate, dimethyl carbonate, diethyl carbonate, methyl ethyl carbonate, γ-butyrolactone, dimethyl sulfoxide, acetonitrile, nitromethane and mixtures thereof.

Where the electrolyte is a solid-state electrolyte, it may include a compound selected from the group consisting of: LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.0}O₅ClO, or any combination thereof.

### Porous Separator

The porous separator 26 may include, in certain variations, a microporous polymeric separator including a polyolefin, including those made from a homopolymer (derived from a single monomer constituent) or a heteropolymer (derived from more than one monomer constituent), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2340 (a trilayer polypropylene/polyethylene/polypropylene separator) available from Celgard LLC.

When the porous separator 26 is a microporous polymeric separator, it may be a single layer or a multi-layer laminate. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylene naphthenate, polybutene, polymethylpentene, polyolefin copolymers, acrylonitrile-butadiene styrene copolymers (ABS), polystyrene copolymers, polymethylmethacrylate (PMMA), polysiloxane polymers (e.g., polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF—hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, or a combination thereof.

Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various commercially available polymers and commercial products for forming the separator 26 are contemplated, as well as the many manufacturing methods that may be employed to produce such a microporous polymer separator 26.

### Solid-State Electrolyte

In various aspects, the porous separator 26 and the electrolyte 30 may be replaced with a solid state electrolyte (SSE) that functions as both an electrolyte and a separator. The SSE may be disposed between a positive electrode and a negative electrode. The SSE facilitates transfer of lithium ions, while mechanically separating and providing electrical insulation between the negative and positive electrodes 22, 24. By way of non-limiting example, SSEs may include LiTi₂(PO₄)₃, Li_{1.3}Al_{0.3}Ti_{1.7}(PO₄)₃ (LATP), LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof.

### Current Collectors

The negative and positive electrodes 22, 24 are generally associated with the respective negative and positive electrode current collectors 32, 34 to facilitate the flow of electrons between the electrode and the external circuit 40. The current collectors 32, 34 are electrically conductive and can include metal, such as a metal foil, a metal grid or screen, or expanded metal. Expanded metal current collectors refer to metal grids with a greater thickness such that a greater amount of electroactive material is placed within the metal grid. By way of non-limiting example, electrically-conductive materials include copper, nickel, aluminum, stainless steel, titanium, alloys thereof, or combinations thereof.

The positive electrode current collector 34 may be formed from aluminum or any other appropriate electrically conductive material known to those of skill in the art. The negative electrode current collector 32 may be formed from copper or any other appropriate electrically conductive material known to those of skill in the art. Negative electrode current collectors do not typically include aluminum because aluminum reacts with lithium, thereby causing large volume expansion and contraction. The drastic volume changes may lead to fracture and/or pulverization of the current collector.

### Positive & Negative Electrodes

The positive electrode 24 may be formed from or include a lithium-based active material that can undergo lithium intercalation and deintercalation, alloying and dealloying, or plating and stripping, while functioning as the positive terminal of the lithium-ion battery 20. The positive electrode 24 may include a positive electroactive material. Positive electroactive materials may include one or more transition metal cations, such as manganese (Mn), nickel (Ni), cobalt (Co), chromium (Cr), iron (Fe), vanadium (V), and combinations thereof. However, in certain variations, the positive electrode 24 is substantially free of select metal cations, such as nickel (Ni) and cobalt (Co).

Two exemplary common classes of known electroactive materials that can be used to form the positive electrode 24 are lithium transition metal oxides with layered structures and lithium transition metal oxides with spinel phase. For example, in certain instances, the positive electrode 24 may include a spinel-type transition metal oxide, like lithium manganese oxide (Li₍₁₊ₓ₎Mn₍₂₋ₓ₎O₄), where x is typically <0.15, including LiMn₂O₄ (LMO) and lithium manganese nickel oxide LiMn_{1.5}Ni_{0.5}O₄ (LMNO). In other instances, the positive electrode 24 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1 (e.g., LiNi_{0.6}Mn_{0.2}Co_{0.2}O₂, LiNi_{0.7}Mn_{0.2}Co_{0.1}O₂, LiNi_{0.8}Mn_{0.1}Co_{0.1}O₂, and/or LiMn_{0.33}Ni_{0.33}Co_{0.33}O₂), a lithium nickel cobalt metal oxide (LiNi_{(1-x-y)}CoₓM_{y}O₂), where 0<x<1, 0<y<1 and M may be Al, Mg, Mn, or the like. Other known lithium-transition metal compounds such as lithium iron phosphate (LiFePO₄), lithium iron fluorophosphate (Li₂FePO₄F), or lithium Manganese iron phosphate (LiMnFePO₄) can also be used. In certain aspects, the positive electrode 24 may include an electroactive material that includes manganese, such as lithium manganese oxide (Li₍₁₊ₓ₎Mn₍₂₋ₓ₎O₄), and/or a mixed lithium manganese nickel oxide (LiMn₍₂₋ₓ₎NiₓO₄), where 0≤x≤1. In a lithium-sulfur battery, positive electrodes may have elemental sulfur as the active material or a sulfur-containing active material.

The positive electroactive materials may be powder compositions. The positive electroactive materials may be intermingled with an optional electrically conductive material (e.g., electrically-conductive particles) and a polymeric binder. The binder may both hold together the positive electroactive material and provide ionic conductivity to the positive electrode 24.

The negative electrode 22 may include a negative electroactive material as a lithium host material capable of functioning as a negative terminal of the lithium-ion battery 20. Common negative electroactive materials include lithium insertion materials or alloy host materials. Such materials can include carbon-based materials, such as lithium-graphite intercalation compounds, lithium-silicon compounds, lithium-tin alloys, or lithium titanate Li₄₊ₓTi₅O₁₂, where 0≤x≤3, such as Li₄Ti₅O₁₂ (LTO).

“In certain aspects, the negative electrode 22 includes metallic lithium and the negative electrode 22 is a lithium metal electrode (LME). The lithium-ion battery 20 may be a lithium-metal battery or cell. Metallic lithium for use in the negative electrode of a rechargeable battery has various potential advantages, including having the highest theoretical capacity and lowest electrochemical potential. Thus, batteries incorporating lithium-metal anodes can have a higher energy density that can potentially double storage capacity, so that the battery may be half the size, but still last the same amount of time as other lithium-ion batteries.

In certain variations, the negative electrode 22 may optionally include an electrically conductive material, as well as one or more polymeric binder materials to structurally hold the lithium material together.

Advanced energy storage devices and systems are in demand to satisfy energy and/or power requirements for a variety of products, including automotive products such as start-stop systems (e.g., 12V start-stop systems), mild hybrid systems (e.g., 48V hybrid systems), battery assisted systems, hybrid electric vehicles (“HEVs”), and electric vehicles (“EVs”). Capacitors can provide high power density (e.g., about 10 kW/kg) in power based applications and lithium ion batteries can deliver high energy densities (e.g., about 50-300 Wh/kg). In various instances, capacitor assisted batteries (“CABs”) (e.g., a lithium ion capacitor hybridized with a lithium ion battery in a single cell core) may provide several advantages, such as enhanced pulsed power capability at both warm and cold temperatures compared with lithium ion batteries. For example, integrated capacitor materials or super capacitor materials may be used to supply current during engine startup so as to limit current draw from the lithium ion battery during start-up, in particular in the instance of cold weather applications, such as cold-cranking.

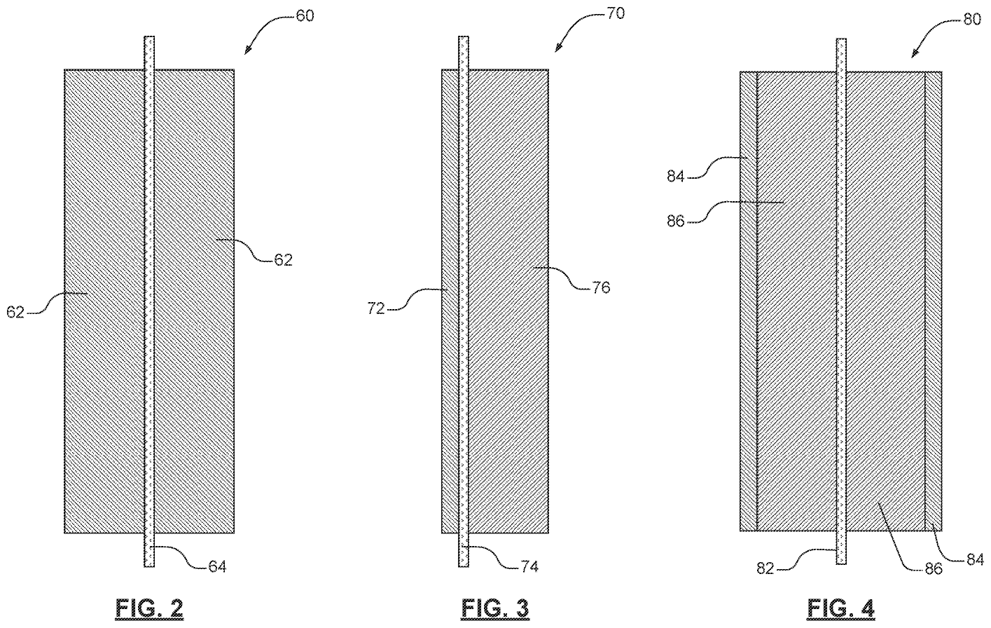

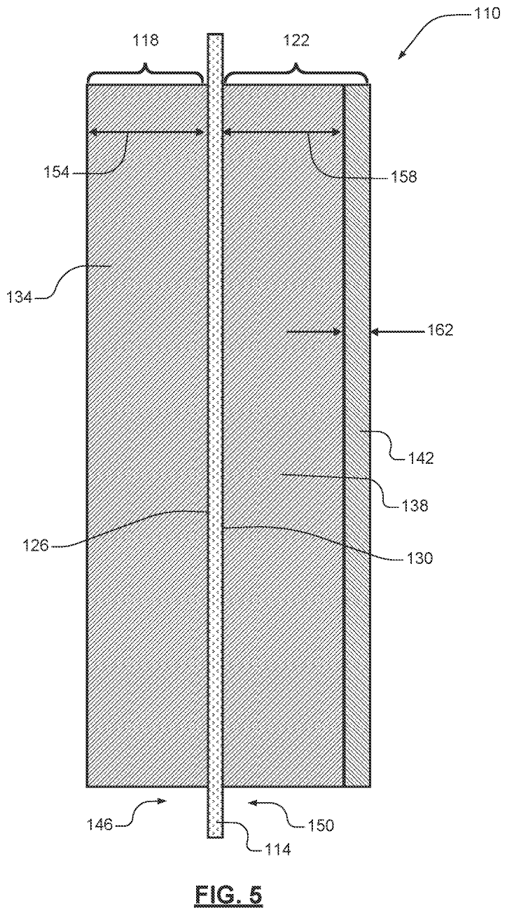

Capacitor materials may be integrated into electrochemical cells in a variety of ways. In one example, as shown in FIG. 2, an electrochemical cell includes at least one capacitive electrode 60 that includes capacitive electroactive coatings 62 on both sides of a current collector 64. In another example, as shown in FIG. 3, a double-sided electrode 70 includes a capacitive electroactive coating 72 on one side of a current collector 74 and a battery electroactive coating 76 on the other side of the current collector 74. In yet another example, as shown in FIG. 4, a double-sided electrode 80 is symmetric, with each side of a current collector 82 including a capacitive electrode coating 84 and a battery electroactive coating 86.

### Asymmetric Hybrid Electrodes

In various aspects, the present disclosure provides an asymmetric hybrid electrode for an electrochemical cell, such as a CAB. The electrode includes both a battery electroactive material and a capacitive electroactive material. The electrode includes a current collector, a first electroactive portion on a first surface of the current collector and a second electroactive portion on a second surface of the current collector. The first and second electroactive portions are asymmetric. The first electroactive portion includes a first battery layer including a first battery electroactive material and a first binder. The second electroactive portion includes a second battery layer and a capacitive layer. The second battery layer includes a second battery electroactive material and a second binder. The capacitive layer includes a capacitive electroactive material and a third binder. In certain aspects, the capacitive layer further includes a third battery electroactive material. The first, second, and third battery electroactive materials are both positive electroactive materials or both negative electroactive materials. Accordingly, the electrode is a positive asymmetric hybrid electrode or a negative asymmetric hybrid electrode.

The asymmetric hybrid electrode has a low capacitor hybridization ratio (CHR) when compared to the electrodes of FIGS. 2-4. The CHR is defined as shown in the equation below:

$$C H R = \frac{{C}_{C M}}{{C}_{C M} + {C}_{B M}} \times 100 \% ,$$

where C_{CM} is capacitive material capacity and C_{BM} is battery material capacity. In certain aspects, the asymmetric hybrid electrode according to various aspects of the present disclosure has a CHR of less than or equal to about 1% (e.g., less than or equal to about 0.9%, less than or equal to about 0.8%, less than or equal to about 0.7%, less than or equal to about 0.6%, less than or equal to about 0.5%, less than or equal to about 0.4%, less than or equal to about 0.3%, less than or equal to about 0.2%, less than or equal to about 0.1%, less than or equal to about 0.09%, less than or equal to about 0.08%, less than or equal to about 0.07%, less than or equal to about 0.06%, less than or equal to about 0.05%, less than or equal to about 0.04%, less than or equal to about 0.03%, less than or equal to about 0.02%, or less than or equal to about 0.01%). In certain aspects, the CHR is greater than or equal to 0% (e.g., greater than or equal to 0.01%, greater than or equal to 0.02%, greater than or equal to 0.03%, greater than or equal to 0.04%, greater than or equal to 0.05%, greater than or equal to 0.06%, greater than or equal to 0.07%, greater than or equal to 0.08%, greater than or equal to 0.09%, greater than or equal to 0.1%, greater than or equal to 0.2%, greater than or equal to 0.5%). In one example, the CHR is in a range of 0.01-1%. Moreover, the CHR is tunable by modifying thicknesses of layers and/or composition of the capacitive layer. In one example, the capacitive layer is free of battery electrode material and the CHR is 0. The asymmetric hybrid electrode may therefore have improved mass and volumetric energy densities compared to the electrodes of FIGS. 2-4.

Referring to FIG. 5, an asymmetric hybrid electrode 110 according to various aspects of the present disclosure is provided. The electrode 110 includes a current collector 114, a first electroactive portion 118, and a second electroactive portion 122. The first electroactive portion 118 is disposed on a first surface 126 of the current collector 114. The second electroactive portion 122 is disposed on a second surface 130 of the current collector 114 opposite the first surface 126.

The first electroactive portion 118 includes a first battery layer 134. The second electroactive portion 122 includes a second battery layer 138 and a capacitive layer 142. In certain aspects, the second battery layer 138 is disposed between the current collector 114 and the capacitive layer 142, as shown. However, in certain other aspects, a capacitive layer is disposed between a current collector and a second battery electroactive layer, such as directly on the current collector.

The first and second electroactive portions 118, 122 are asymmetric about the current collector 114. Accordingly, the first and second portions 118, 122 differ in number of layers, type of layers (i.e., battery, fully capacitive, hybrid), composition of layers, and/or thickness of layers. In one example, the first and second battery layers 134, 138 are substantially identical and the first electroactive portion 118 is free of a capacitive or hybrid electroactive layer.

In certain aspects, the first battery layer 134 is disposed directly on the first surface 126 of the current collector 114 without another electroactive layer disposed therebetween. The first battery layer 134 may be the only electroactive layer on a first side 146 of the current collector 114 such that the first battery layer 134 forms an outermost layer on the first side 146. The second battery layer 138 is disposed directly on the second surface 130 of the current collector 114 without another electroactive layer therebetween. The capacitive layer 142 is disposed directly on the second battery layer 138 without another electroactive layer therebetween. The second battery layer 138 and the capacitive layer 142 may be the only electroactive layers on a second side 150 of the electrode 110 such that the capacitive layer 142 forms an outermost layer on the second side 150. Therefore, the electrode 110 may include exactly three electroactive layers.

The first battery layer 134 defines a first thickness 154. In certain aspects, the first thickness 154 is less than about 5 mm (e.g., 10-500 μm, 10-250 μm, 10-100 μm, 10-20 μm, 20-50 μm, 50-100 μm, 100-250 μm, 250-500 μm, 500 μm-1 mm, 1-2 mm, about 2-3 mm, 3-4 mm, or 4-5 mm). In one example, the first thickness 154 is about 10-100 μm. The second battery layer 138 defines a second thickness 158. In certain aspects, the second thickness 158 is less than about 5 mm (e.g., 10-500 μm, 10-250 μm, 10-100 μm, 10-20 μm, 20-50 μm, 50-100 μm, 100-250 μm, 250-500 μm, 500 μm-1 mm, 1-2 mm, about 2-3 mm, 3-4 mm, or 4-5 mm). In one example, the second thickness 158 is about 10-100 μm. The first and second thicknesses 154,158 may be the same or different.

The capacitive layer 142 defines a third thickness 162. In certain aspects, the third thickness 162 is 1-200 μm (e.g., 1-10 μm, 1-5 μm, 5-10 μm, 10-25 μm, 25-50 μm, 50-100 μm, 100-150 μm, 150-200 μm).

The current collector 114 includes an electrically-conductive material, such as those described above in the discussion accompanying FIG. 1.

The first battery layer 134 includes a first battery electroactive material and a first binder. The second battery layer 138 includes a second battery electroactive material and a second binder. The capacitive layer 142 includes a capacitive electroactive material and a third binder. In certain aspects, the capacitive layer 142 further includes a third battery electroactive material. When the capacitive layer 142 includes the third battery electroactive material, it may also be referred to as a “hybrid layer.” The first battery layer 134, the second battery layer 138, and/or the capacitive layer 142 may further include a conductive additive.

The first and second battery layers 134, 138 may have the same composition or different compositions. In certain aspects, each of the first and second battery layers 134, 138 includes the respective first or second battery electroactive material at 80-98% by weight, the respective first or second binder at 0.5-10% by weight, and the conductive additive at 0.5-10% by weight.

The capacitive layer 142 generally includes electroactive material (capacitive electroactive material plus optional battery electroactive material) at 70-98 by weight, the third binder at 1-15% by weight, and the conductive additive at 1-15% by weight. The third battery electroactive material is present at about 0-95% by weight of the capacitive electroactive material (e.g., 0-20%, 0-5%, 5-10%, 10-15%, 15-20%, 15-25%, 25-35%, 35-45%, 45-55%, 55-65%, 65-75%, 75-85%, or 85-95%). In one example, the third battery electroactive material is present at less than 20% by weight of the capacitive electroactive material.

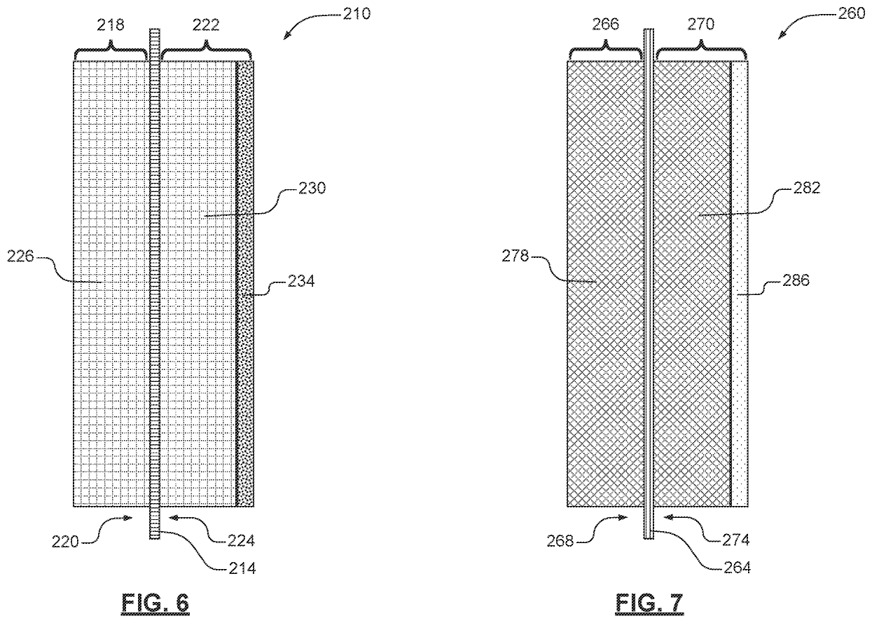

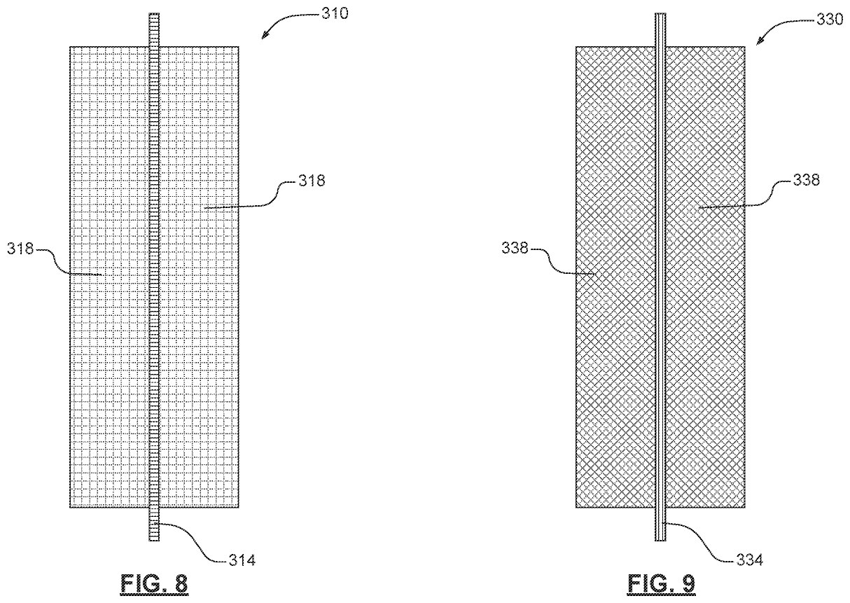

The first, second, and third battery electroactive materials are all positive battery electroactive materials (see discussion accompanying FIG. 6) or all negative battery electroactive materials (see discussion accompanying FIG. 7). The first, second, and third battery electroactive materials may be the same or different. In certain aspects, the first, second, and third battery electroactive materials are the same.

The first, second, and third battery electroactive materials may be in the form of particles. The first, second, and third battery electroactive material particles have respective first, second, and third average particles sizes. The first, second, and third average particles sizes may be the same or different. In certain aspects, each of the first, second, and third average particle sizes are in a range of 0.5-50 μm (e.g., 0.5-30 μm, 0.5-15 μm, 0.5-10 μm, 0.5-5 μm, 0.5-2 μm, 0.5-1 μm, 5-50 μm, 5-30 μm, 5-15 μm, 15-30 μm, or 30-50 μm). In one example, the first, second, and third average particle sizes are in a range of 5-15 μm.

The capacitive electroactive material may include a metal oxide (e.g., MOₓ, where M is Co, Ru, Nb, Pb, Ge, Ni, Cu, Fe, Mn, Rh, Pd, Cr, Mo, and/or W); a metal sulfide (e.g., TiS₂, CuS, and/or FeS); a carbon (e.g., activated carbon, graphene, carbon nanotubes, graphite, carbon aerogel, carbide-derived carbon, and/or graphene oxide); a polymer (e.g., polyaniline, polyacetylene, poly(3-methyl thiophene), polypyrrole, poly(paraphenylene), polyacene, and/or polythiophene), or any combination thereof. In certain aspects, the capacitive electroactive material includes activated carbon. In certain aspects, the capacitive electroactive material includes graphene. The above capacitive electroactive materials may be used in a positive hybrid electrode or a negative hybrid electrode.

The capacitive electroactive material may be in the form of particles. The particles may define an average size of 50 nm-20 μm (e.g., 1-8 μm, 2-4 μm). Smaller capacitive electroactive materials may facilitate the formation of thinner capacitive layers.

The first, second, and third binders may be independently selected from polyvinylidene difluoride (PVDF), polytetrafluoroethylene (PTFE), ethylene propylene diene monomer (EPDM) rubber, or carboxymethyl cellulose (CMC), a nitrile butadiene rubber (NBR), styrene butadiene rubber (SBR), polyacrylate (PAA), lithium polyacrylate (LiPAA), sodium polyacrylate (NaPAA), sodium alginate, lithium alginate, or any combination thereof. In certain aspects, the first, second, and third binders are the same. In one example, the first, second, and third binders all include PVDF.

With reference to FIG. 6, a positive asymmetric hybrid electrode 210 according to various aspects of the present disclosure is provided. The electrode 210 is similar to the electrode 110 of FIG. 5. The electrode 210 generally includes a positive electrode current collector 214, a first electroactive portion 218 on a first side 220 of the current collector 214, and a second electroactive portion 222 on a second side 224 of the current collector 214.

The first electroactive portion 218 includes a first battery layer 226. The second electroactive portion 222 includes a second battery layer 230 and a capacitive layer 234. The first battery layer 226 includes a first positive battery electroactive material and a first binder. The second battery layer 230 includes a second positive battery electroactive material and a second binder. The capacitive layer 234 includes a capacitive electroactive material, such as those described with reference to the capacitive layer 142 of FIG. 5, and a third binder. The capacitive layer 234 may optionally further include a third positive battery electroactive material.

The first, second, and third positive battery electroactive materials may include any of the positive electroactive materials described in the discussion accompanying FIG. 1. Additionally or alternatively, in certain aspects, the positive battery electroactive materials are independently selected from an olivine compound, a rock salt layered oxide, a spinel, a tavorite, a borate, a silicate, an organic compound, other types of positive electrode materials, or any combination thereof. The olivine compound may include LiV₂(PO₄)₃, LiFePO₄ (LFP), LiCoPO₄, and/or a lithium manganese iron phosphate (LMFP), by way of example. LMFPs may include LiMnFePO₄ and/or LiMnₓFe₁₋ₓPO₄, where 0≤x≤1, by way of example. Examples of LiMnₓFe₁₋ₓPO₄, where 0≤x≤1, include LiMn_{0.7}Fe_{0.3}PO₄, LiMn_{0.6}Fe_{0.4}PO₄, LiMn_{0.8}Fe_{0.2}PO₄, and LiMn_{0.75}Fe_{0.25}PO₄, by way of example. The rock salt layered oxide may include LiNiₓMn_{y}Co_{1-x-y}O₂, LiNiₓMn₁₋ₓO₂, Li₁₊ₓMO₂, (e.g., LiCoO₂, LiNiO₂, LiMnO₂, and/or LiNi_{0.5}Mn_{0.5}O₂), a lithium nickel manganese cobalt oxide (NMC) (e.g., NMC 111, NMC 523, NMC 622, NMC 721, and/or NMC 811), and/or a lithium nickel cobalt aluminum oxide (NCA)), by way of example. The spinel may include LiMn₂O₄ and/or LiNi_{0.5}Mn_{1.5}O₄, by way of example. The tavorite compound may include LiVPO₄F, by way of example. The borate compound may include LiFeBO₃, LiCoBO₃, and/or LiMnBO₃, by way of example. The silicate compound may include Li₂FeSiO₄, Li₂MnSiO₄, and/or LiMnSiO₄F, by way of example. The organic compound may include dilithium(2,5-dilithiooxy)terephthalate (as described in Steven Renault, Sébastien Gottis, Anne-Lise Barrés, Matthieu Courty, Oliver Chauvet, Franck Dolhem, and Philippe Poizot, A Green Li-Organic Battery Working as a Fuel Cell in Case of Emergency, ELEC. SUPPLEMENTARY INFO. FOR ENERGY & ENVTL. SCI. (2013), incorporated herein by reference in its entirety), and/or polyimide, by way of example. An example of another type of positive electroactive material is a sulfur-containing material, such as sulfur. In one example, the positive electroactive material includes one or more olivine compounds and has a tap density of less than about 2 g/cm³, optionally less than about 1.3 g/cm³, or optionally less than about 1 g/cm³.

Some positive electroactive materials, such as olivine compounds, rock salt layered oxides, and/or spinels, may be a coated and/or doped. Dopants can include magnesium (Mg), aluminum (Al), yttrium (Y), scandium (Sc), and the like. For example, the positive electroactive material may include one or more of LiMn_{0.7}Mg_{0.05}Fe_{0.25}PO₄, LiMn_{0.75}Al_{0.05}Fe_{0.2}PO₄, LiMn_{0.75}Al_{0.03}Fe_{0.22}PO₄, LiMn_{0.75}Al_{0.03}Fe_{0.22}PO₄, LiMn_{0.7}Y_{0.02}Fe_{0.28}PO₄, LiMn_{0.7}Mg_{0.02}Al_{0.03}Fe_{0.25}PO₄, and the like. In certain aspects, a positive electroactive material including an LMFP compound may be doped with about 10% by weight of one or more dopants.

In certain aspects, the capacitive layer 234 is a hybrid electroactive layer including the third positive battery electroactive material. The positive electrode current collector 214 includes aluminum. The first, second, and third positive battery electroactive materials include LFP. The capacitive electroactive material includes activated carbon.

Referring to FIG. 7, a negative asymmetric hybrid electrode 260 according to various aspects of the present disclosure is provided. The electrode 260 is similar to the electrode 110 of FIG. 5. The electrode 260 generally includes a negative electrode current collector 264, a first electroactive portion 266 on a first side 268 of the current collector 264, and a second electroactive portion 270 on a second side 274 of the current collector 264.

The first electroactive portion 266 includes a first battery layer 278. The second electroactive portion 270 includes a second battery layer 282 and a capacitive layer 286. The first battery layer 278 includes a first negative battery electroactive material and a first binder. The second battery layer 282 includes a second negative battery electroactive material and a second binder. The capacitive layer 286 includes a capacitive electroactive material, such as those described with reference to the capacitive layer 142 of FIG. 5, and a third binder. The capacitive layer 286 may optionally further include a third negative battery electroactive material.

The first, second, and third negative battery electroactive materials may include any of the negative electroactive materials described in the discussion accompanying FIG. 1. Additionally or alternatively, in certain aspects, the negative battery electroactive materials are independently selected from a carbonaceous material (e.g., carbon nanotubes, graphite, graphene), a lithium-containing material (e.g., lithium, a lithium alloy), a tin-containing material (e.g., tin, a tin alloy), a lithium titanium oxide (e.g., Li₄Ti₅O₁₂), a metal oxide (e.g., V₂O₅, SnO₂, Co₃O₄), a metal sulfide (e.g., FeS), a silicon-containing material (e.g., silicon, silicon oxide, a silicon alloy, silicon-graphite, silicon oxide graphite, silicon alloy graphite, any of which may optionally be lithiated), or any combination thereof. In one example, the negative battery electroactive material includes silicon-graphite including an admixture of about 95% graphite by weight and about 5% silicon by weight.

In certain aspects, the capacitive layer 286 is a hybrid electroactive layer including the third negative battery electroactive material. The current collector 264 includes copper. The first, second, and third negative battery electroactive materials include graphite. The capacitive electroactive material includes graphene.

### Hybrid Electrochemical Cells

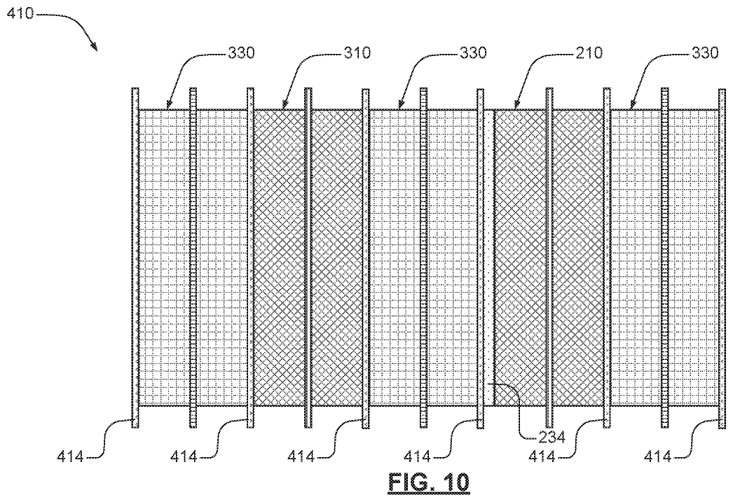

In various aspects, the present disclosure provides, a hybrid electrochemical cell, such as a CAB. The hybrid electrochemical cell includes at least one positive asymmetric hybrid electrode (e.g., the electrode 210 of FIG. 6) and/or at least one negative asymmetric hybrid electrode (e.g., the electrode 260 of FIG. 7). The electrochemical cell further includes at least one positive battery electrode (e.g., the electrode 310 of FIG. 8, discussed below) and at least one negative battery electrode (e.g., the electrode 330 of FIG. 9, discussed below). The electrochemical cell may include, in certain aspects, one more negative electrode (i.e., negative battery electrode and/or negative asymmetric hybrid electrode) than positive electrodes (i.e., positive battery electrodes and/or positive asymmetric hybrid electrodes). The hybrid electrochemical cell may have a stacking or winding structure.

FIG. 8 depicts a positive battery electrode 310 according to various aspects of the present disclosure. The positive battery electrode 310 includes a positive electrode current collector 314 (e.g., aluminum foil) and two battery layers 318. Each battery layer 318 includes a positive battery electroactive material, such as those described in the discussion accompanying FIG. 6. In one example, the positive battery electroactive material includes LFP. The positive battery electrode 310 may be free of capacitive electroactive material. In certain aspects, the battery layers 318 are substantially identical in composition and thickness.

FIG. 9 depicts a negative battery electrode 330 according to various aspects of the present disclosure. The negative battery electrode 330 includes a negative electrode current collector 334 (e.g., copper foil) and two battery layers 338. Each battery layer 338 includes a negative battery electroactive material, such as those described in the discussion accompanying FIG. 7. In one example, the negative battery electroactive material includes graphite. The negative battery electrode 330 may be free of capacitive electroactive material. In certain aspects, the battery layers 338 are substantially identical in composition and thickness.

In certain aspects, all positive battery electrodes and positive asymmetric hybrid electrodes include the same positive battery electroactive material. However, in other aspects, the electrodes include different positive electroactive materials. In certain aspects, all negative battery electrodes and negative asymmetric hybrid electrodes include the same negative battery electroactive material. However, in other aspects, the electrodes include different negative electroactive materials.

The electrochemical cell further includes a porous separator between each electrode. The porous separator may be similar to the porous separators described above in the discussion accompanying FIG. 1.

The electrochemical cell further includes an electrolyte, such as in pores of the electrodes and porous separators. The electrolyte may be a liquid electrolyte or a semi-solid electrolyte. In certain aspects, the electrolyte includes a lithium salt. The lithium salt may include lithium bis(oxalato)borate (LiBOB), lithium oxalyldifluoroborate (LiODFB), lithium fluoroalkylphosphate (LiFAP), LiPF₆, LiAsF₆, LiBF₄, LiClO₄, LiCF₃SO₃, LiTFSI, lithium bis(fluorosulfonyl)imide (LiFSI), lithium bis-trifluoromethanesulfonimide (LITFSI), or any combination thereof. In certain aspects, the electrochemical cell alternatively includes a solid-state electrolyte that serves as both an electrolyte and a separator.

Examples of hybrid electrochemical cells or CABs are shown in FIGS. 10-12 and described below. The electrochemical cells include the electrodes of FIGS. 6-9. However, the electrochemical cells may additionally or alternatively include other electrodes according to various aspects of the present disclosure.

With reference to FIG. 10, an example hybrid electrochemical cell 410 according to various aspects of the present disclosure is provided. The electrochemical cell 410 includes the positive battery electrode 310 (see also FIG. 8 and accompanying discussion), the negative battery electrode 330 (see also FIG. 9 and accompanying discussion, and the positive asymmetric hybrid electrode 210 (see FIG. 6 and accompanying discussion). More particularly, the electrochemical cell 410 includes one positive battery electrode 310, three negative battery electrodes 330, and one positive asymmetric hybrid electrode 210. The positive asymmetric hybrid electrode 210 is disposed between two of the negative battery electrodes 330. In certain aspects, the positive asymmetric hybrid electrode 210 is oriented such that the capacitive layer 234 is closer to a center of the electrochemical cell 410. A porous separator 414 is disposed between each of the electrodes 310,330,210.

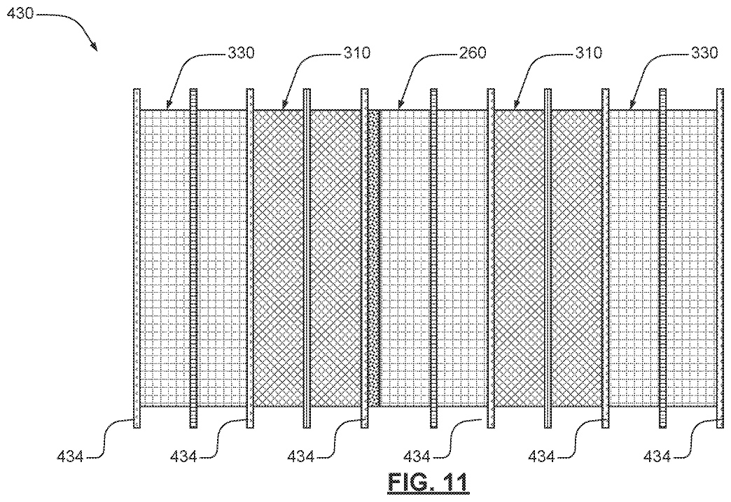

Referring to FIG. 11, another hybrid electrochemical cell 430 according to various aspects of the present disclosure is provided. The electrochemical cell 430 includes the positive battery electrode 310 (see also FIG. 8 and accompanying discussion), the negative battery electrode 330 (see also FIG. 9 and accompanying discussion, and the negative asymmetric hybrid electrode 260 (see FIG. 7 and accompanying discussion). More particularly, the electrochemical cell 430 includes two positive battery electrodes 310, two negative battery electrodes 330, and one negative asymmetric hybrid electrode 260. The negative asymmetric hybrid electrode 260 is disposed between two positive battery electrodes 310. A porous separator 434 is disposed between each of the electrodes 310, 330, 260.

With reference to FIG. 12, yet another hybrid electrochemical cell 450 according to various aspects of the present disclosure is provided. The electrochemical cell 450 includes the positive battery electrode 310 (see also FIG. 8 and accompanying discussion), the negative battery electrode 330 (see also FIG. 9 and accompanying discussion), the positive asymmetric hybrid electrode 210 (see FIG. 6 and accompanying discussion), and the negative asymmetric hybrid electrode 260 (see FIG. 7 and accompanying discussion). More particularly, the electrochemical cell 450 includes two positive battery electrodes 310, three negative battery electrodes 330, one positive asymmetric hybrid electrode 210, and one negative asymmetric hybrid electrode 260. The positive asymmetric hybrid electrode 210 is disposed between two negative battery electrodes 330. The negative asymmetric hybrid electrode 260 is disposed between the two positive battery electrodes 310. A porous separator 454 is disposed between each of the electrodes 310, 330, 210, 260.

### Method of Fabricating a Hybrid Electrode

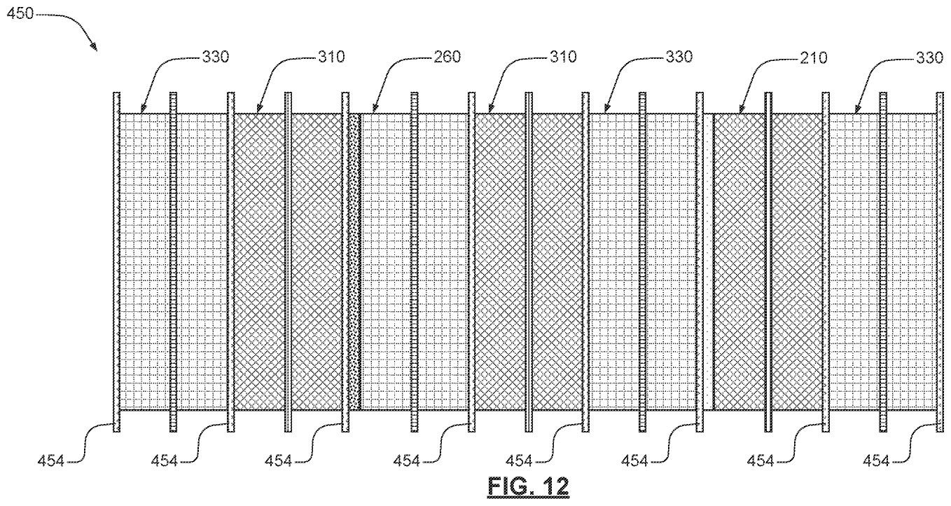

In various aspects, the present disclosure provides, a method of fabricating an asymmetric hybrid electrode. With reference to FIG. 13, the method generally includes forming a pair of battery layers at 510, forming a capacitive electrode layer at 514, and optionally assembling an electrochemical cell at 518. The method will be described with reference to the asymmetric hybrid electrode 110 of FIG. 5; however, the method is equally applicable to fabrication of other asymmetric hybrid electrodes of the present disclosure. For example, step 514 may be performed prior to step 510 to form a capacitive layer that is disposed directly on a current collector, with a pair of battery layers disposed on the capacitive layer and the other side of the current collector, respectively.

At 510, the method includes forming a pair of battery layers.

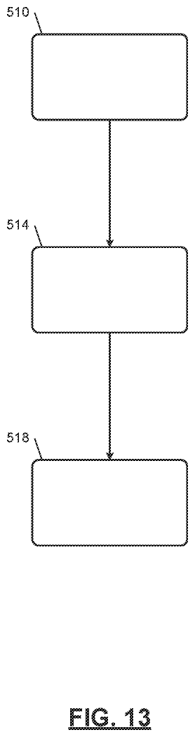

Referring to FIG. 14, a method of coating the current collector 114 according to various aspects of the present disclosure is provided. More particularly, a first die 610 applies first slurries 614 to the first and second surfaces 126, 130 of the current collector 114. Each slurry 614 includes the respective first or second battery electroactive material, the respective first or second binder, the optional conductive filler, and a first solvent.

With reference to FIG. 15, the first slurry 614 (FIG. 14) is dried to form electrode precursor layers 626 according to various aspects of the present disclosure. The drying includes removing at least a portion of the first solvent from the slurry 614, such as substantially all of the first solvent.

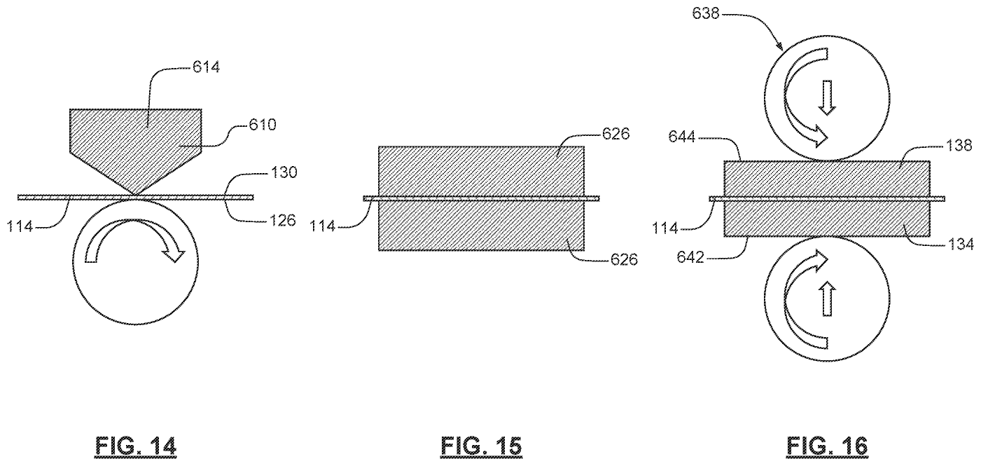

Referring to FIG. 16, the electrode precursor layers 626 (FIG. 15) are calendered by a first pressing machine 638 to form the first and second battery layers 134, 138 according to various aspects of the present disclosure. After the calendaring, third and fourth surfaces 642, 644 of the first and second battery layers 134, 138, respectively, may be substantially smooth.

Returning to FIG. 13, at 514, the method includes forming a capacitive layer.

With reference to FIG. 17, a method of coating the second battery layer 138 according to various aspects of the present disclosure is provided. More particularly, a second die 654 applies a second slurry 658 to the fourth surface 644 of the second battery layer 138. In certain other aspects, the second slurry 658 may be applied by a vertical coating machine configured to form thin layers. The slurry 658 may include the capacitive electroactive material, the third binder, the optional third battery electroactive material, the optional conductive filler, and a second solvent.

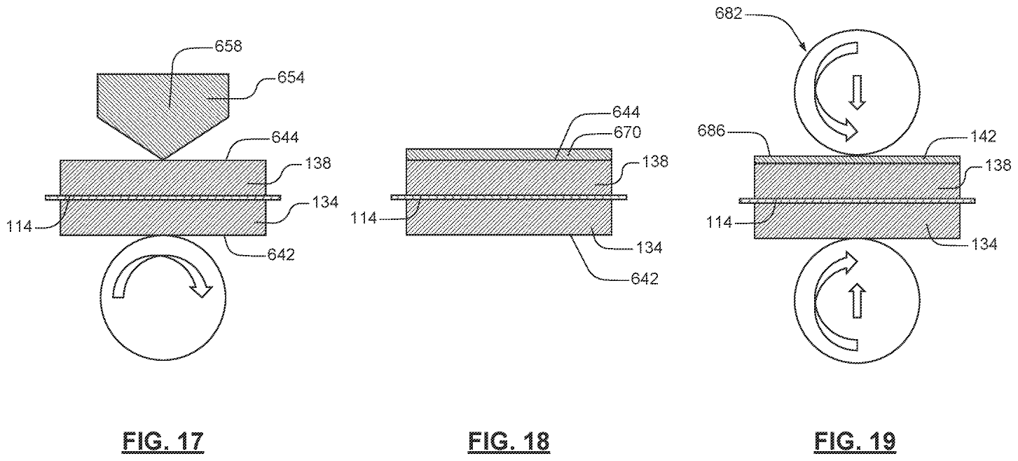

Referring to FIG. 18, the second slurry 658 (FIG. 18) is dried to form a capacitive precursor layer 670 according to various aspects of the present disclosure. The drying includes removing at least a portion of the second solvent, such as substantially all of the second solvent.

With reference to FIG. 19, the capacitive precursor layer 670 (FIG. 18) is calendered by a second pressing machine 682 to form the capacitive layer 142 according to various aspects of the present disclosure. After the calendaring, a fifth surface 686 of the capacitive layer 142 may be substantially smooth.

In certain aspects, the method further includes notching to form the asymmetric hybrid capacitive electrode 110.

Returning to FIG. 13, the method may further include assembling an electrochemical cell including the asymmetric hybrid electrode according to known methods. The electrochemical cell may be similar to the electrochemical cells 410, 430, and 450 of FIGS. 10, 11, and 12, respectively.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An asymmetric hybrid electrode for a capacitor-assisted battery comprising:
a current collector including an electrically-conductive material;
a first electroactive portion on a first surface of the current collector, the first electroactive portion including,
a first battery layer including,
a first battery electroactive material, and
a first binder;
a second electroactive portion on a second surface of the current collector opposite the first surface, the second electroactive portion including,
a second battery layer including,
a second battery electroactive material, and
a second binder; and
a capacitive layer including,
a capacitive electroactive material, and
a third binder, wherein
the first electroactive portion and the second electroactive portion are asymmetric,
the first battery electroactive material and the second battery electroactive material are both positive electroactive materials or both negative electroactive materials, and
the asymmetric hybrid electrode has a capacitor hybridization ratio of 0.01-1%.

2. The asymmetric hybrid electrode of claim 1, wherein the capacitive layer further includes a third battery electroactive material.

3. The asymmetric hybrid electrode of claim 2, wherein the capacitive layer includes the third battery electroactive material at less than or equal to about 95% by weight of the capacitive electroactive material.

4. The asymmetric hybrid electrode of claim 3, wherein the capacitive layer includes the third battery electroactive material at less than or equal to about 20% by weight of the capacitive electroactive material.

5. The asymmetric hybrid electrode of claim 2, wherein the first battery electroactive material, the second battery electroactive material, and the third battery electroactive material are the same.

6. The asymmetric hybrid electrode of claim 1, wherein the first binder, the second binder, and the third binder are the same.

7. The asymmetric hybrid electrode of claim 6, wherein the first binder, the second binder, and the third binder include polyvinylidene fluoride.

8. The asymmetric hybrid electrode of claim 1, wherein the capacitor hybridization ratio is less than or equal to about 0.7%.

9. The asymmetric hybrid electrode of claim 1, wherein the second battery layer is between the capacitive layer and the current collector.

10. The asymmetric hybrid electrode of claim 9, wherein
the first battery layer is directly on the first surface of the current collector,
the second battery layer is directly on the second surface of the current collector, and
the capacitive layer is directly on the second battery layer.

11. The asymmetric hybrid electrode of claim 1, wherein
the first battery layer defines a first thickness of less than 5 mm, and
the second battery layer defines a second thickness of less than 5 mm.

12. The asymmetric hybrid electrode of claim 11, wherein the first thickness and the second thickness are substantially the same.

13. The asymmetric hybrid electrode of claim 1, wherein the capacitive layer defines a thickness in a range of 1-200 μm.

14. The asymmetric hybrid electrode of claim 1, wherein the first battery electroactive material and the second battery electroactive material are the same.

15. The asymmetric hybrid electrode of claim 1, wherein the first battery electroactive material and the second battery electroactive material are positive electroactive materials.

16. The asymmetric hybrid electrode of claim 15, wherein
the positive electroactive materials include an olivine compound,
the capacitive electroactive material includes activated carbon, and
the electrically-conductive material includes aluminum.

17. The asymmetric hybrid electrode of claim 1, wherein the first battery electroactive material and the second battery electroactive material are negative electroactive materials.

18. The asymmetric hybrid electrode of claim 17, wherein
the negative electroactive materials include a carbon-based battery electroactive material,
the capacitive electroactive material includes a carbon-based capacitive electroactive material, and
the electrically-conductive material includes copper.

19. An electrochemical cell comprising:
the asymmetric hybrid electrode of claim 1;
a positive battery electrode; and
a negative battery electrode.

20. A method of manufacturing an asymmetric hybrid electrode for an electrochemical cell, the method comprising:
forming a first battery layer on a first surface of a current collector, the first battery layer including a first battery electroactive material and a first binder, the current collector including an electrically-conductive material;
forming a second battery layer on a second surface of the current collector opposite the first surface, the second battery layer including a second battery electroactive material and a second binder; and
forming a capacitive layer on the second battery layer, the capacitive layer including a capacitive electroactive material and a third binder, wherein
the first battery layer defines a first electroactive portion,
the second battery layer and the capacitive layer cooperating to define a second electroactive portion,
the first electroactive portion and the second electroactive portion are asymmetric,
the first battery electroactive material and the second battery electroactive material are both positive electroactive materials or are both negative electrode materials, and
the asymmetric hybrid electrode has a capacitor hybridization ratio of about 0.01-1%.
